(19) United States
(12) Patent Application Publication
(10) Pub. No.: US 2015/0185505 A1
(43) Pub. Date: Jul. 2, 2015

(54) METHOD AND SYSTEM FOR CONTROLLING REFRACTIVE PROPERTY OF A SMART GLASS THROUGH A DISPLAY DEVICE

(71) Applicant: SAMSUNG ELECTRONICS CO., LTD., Suwon-si (KR)

(72) Inventors: Rohit Kanti DAS, Noida (IN); Shilpa CHAUDHARY, Noida (IN)

(73) Assignee: SAMSUNG ELECTRONICS CO., LTD., Suwon-si (KR)

(21) Appl. No.: 14/568,222

(22) Filed: Dec. 12, 2014

(30) Foreign Application Priority Data
Dec. 30, 2013 (IN) 6147/CHE/2013

(51) Int. Cl. G02C 7/08; G02B 27/22; G02C 11/00

(52) U.S. Cl. CPC G02C 7/083; G02C 11/10; G02B 27/2228

(57) ABSTRACT

A method and system for controlling refractive property of a smart glass includes storing user profiles of a plurality of users in a display device. A user profile includes identifying a user wearing the smart glass. Further, the method includes communicating eye prescription details of the user to the smart glass. The eye prescription details are stored in a user profile. Furthermore, the method includes controlling refractive property of the smart glass based on the eye prescription details.

This application claims priority from India Patent Application No. 6147/CHE/2013, filed on Dec. 30, 2013 in the India Patent Office, the disclosure of which is incorporated herein by reference in its entirety.

### TECHNICAL FIELD

The present invention relates to the field of smart glasses and more specifically to the field of controlling the refractive properties of liquid crystal glasses used for 2D and 3D viewing.

### BACKGROUND

There is a steady rise in demand for 3D devices such as 3D television and smart 3D consumer devices. A 3D television conveys depth perception of a 3D scene to a viewer by employing different techniques such as stereoscopic display and multi-view display. 3D glasses along with the 3D television are used to produce 3D vision. A liquid crystal (LC) glass is a type of 3D glass used to present 3D images to a user. Often, users wearing prescription glasses find it difficult to wear a 3D glass as the prescription glass can produce distorted images. Hence, it is desired to change refractive properties of the LC glasses based on the user's eye prescription.

In an existing technique, refractive property of a liquid crystal eye glass (hereafter referred to as eye glass) is controlled by a power supply which feeds a voltage to the liquid crystal. However, a user has to set the voltage of the eye glass according to user's eye prescription. Moreover, the eye glass is not capable of handling a 3D and 2D viewing scenario.

In another existing technique, a progressive lens is provided with an automatic focussing capability. The progressive lens is covered with a liquid crystal display layer and includes a microchip, an accelerometer and a nano-rechargeable battery. The progressive lens provides an uninterrupted vision to a user with wider distance vision, wider intermediate vision and wider reading vision. The accelerometer detects a motion of the user and the microchip adjusts focus of the progressive lens based on tilt of user's head. However, the progressive lens is not generic and is manufactured based on a specific user perception. Further, the progressive lens is not capable of handling the 3D and 2D viewing scenario.

In light of the forgoing discussion, there is a need for a smart glass to provide 2D vision and 3D vision to a user with vision errors. Further, there is a need for controlling the refractive property of the smart glass automatically through a display device based on an eye power of each user.

### SUMMARY

The above mentioned needs are met by employing a system capable of providing both 3D vision and 2D vision for person having vision error. The system allows the automatic controlling of refractive property of the smart glass through a display device.

An example of a method of controlling refractive property of a smart glass includes identifying a user wearing the smart glass. Further, the method includes communicating eye prescription details of the user with the smart glass, wherein the eye prescription details are stored in a user profile. Furthermore, the method includes controlling refractive property of the smart glass based on the eye prescription details.

An example of a smart glass capable of controlling refractive properties includes a transceiver to receive an input signal from a display device. The input signal corresponds to eye prescription details of a user. Further the smart glass includes a microcontroller to identify the input signal. The microcontroller includes a processing unit to process the input signal to identify eye prescription details of the user. Further the microcontroller includes a voltage regulator to generate a voltage signal based on the eye prescription details. The smart glass includes a correction layer to control the refractive property of the smart glass. The refractive property is controlled based on the voltage signal. The smart glass includes an indicator light emitting diode (LED) to convey information to the user. Further, the smart glass includes a rechargeable battery to provide power required for the smart glass.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWING

In the following drawings like reference numbers are used to refer to like elements. Although the following figures depict various examples of the invention, the invention is not limited to the examples depicted in the figures.

FIG. 1 illustrates a block diagram of an environment in accordance with which various embodiments of the present invention can be implemented;

FIG. 2 illustrates architecture of a system providing vision correction to a user, in accordance with one embodiment of the present invention;

FIG. 3 is an exemplary illustration of a smart glass module of FIG. 2, in accordance with another embodiment the present invention;

FIG. 4 is an internal block diagram of a microcontroller embedded in a smart glass;

FIG. 5A is an exemplary illustration of molecular arrangement of different states of matter;

FIG. 5B illustrates the effect of voltage applied on liquid crystal (LC) molecules;

FIG. 6A is a schematic diagram of image formation in an eye when a normal 3D glass is used;

FIG. 6B is a schematic diagram of image formation in an eye when a smart glass is used, in accordance with one embodiment of the invention;

FIG. 7 is a flowchart illustrating steps to control the refractive index of a smart glass;

FIG. 8 is an exemplary illustration of a multi-user scenario viewing a display device;

FIG. 9 illustrates user profiling in a display device, in accordance with one embodiment of the present invention; and

FIG. 10 illustrates the communication between a display device and a smart glass, in accordance with another embodiment of the present invention.

### DETAILED DESCRIPTION

Embodiments of the present disclosure described herein provide a method and system for controlling refractive properties of smart glasses through display devices. The smart glass provides a perfect 3D and 2D vision to a user with vision errors. The smart glass when used in context of 2D gives normal vision to the user and also makes the glass generic so that any myopic user irrespective of the power can use the same glass. Similarly, when the smart glass is incorporated in context of 3D, gives the 3D and normal vision to the user. The system eliminates the need of wearing a 3D glass over a prescription glass for a user with vision error. The smart glass provides 3D vision along with corrected eye vision. Further the smart glass can be used in both 2D viewing scenario and 3D viewing scenario. The refractive property of the smart glass is controlled each time when a user appears before the display device. The refractive property is controlled based on the user's prescription detail stored in the display device or server.

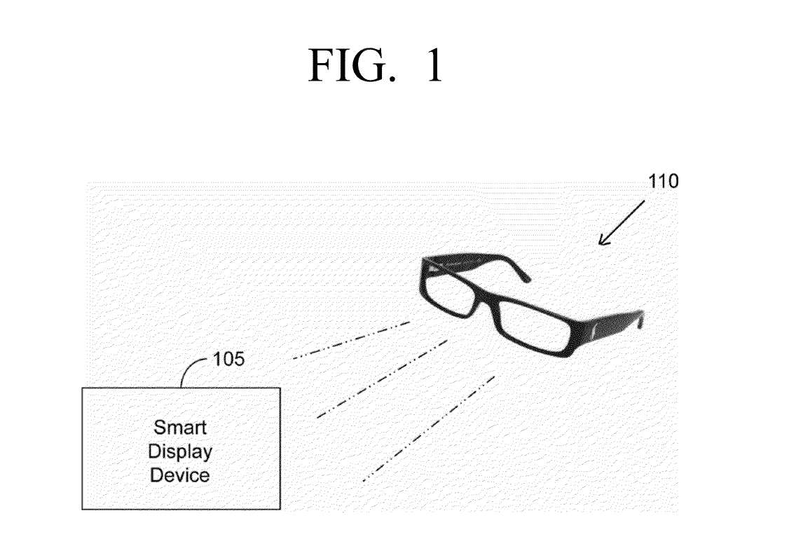

FIG. 1 illustrates a block diagram of an environment in accordance with which various embodiments of the present invention can be implemented. The environment includes a smart display device 105 and a smart glass module 110. Examples of the smart display device 105 include, but are not limited to a smart television, a 3D television, a computer monitor and a smartphone. The smart display device 105 stores user profiles of a plurality of users. The user profile includes information related to a user such as identification information, favourite movies, favourite songs, recommendations and eye prescription details. The smart display device 105 communicates the prescription power information extracted from user profile to the smart glass module 110.

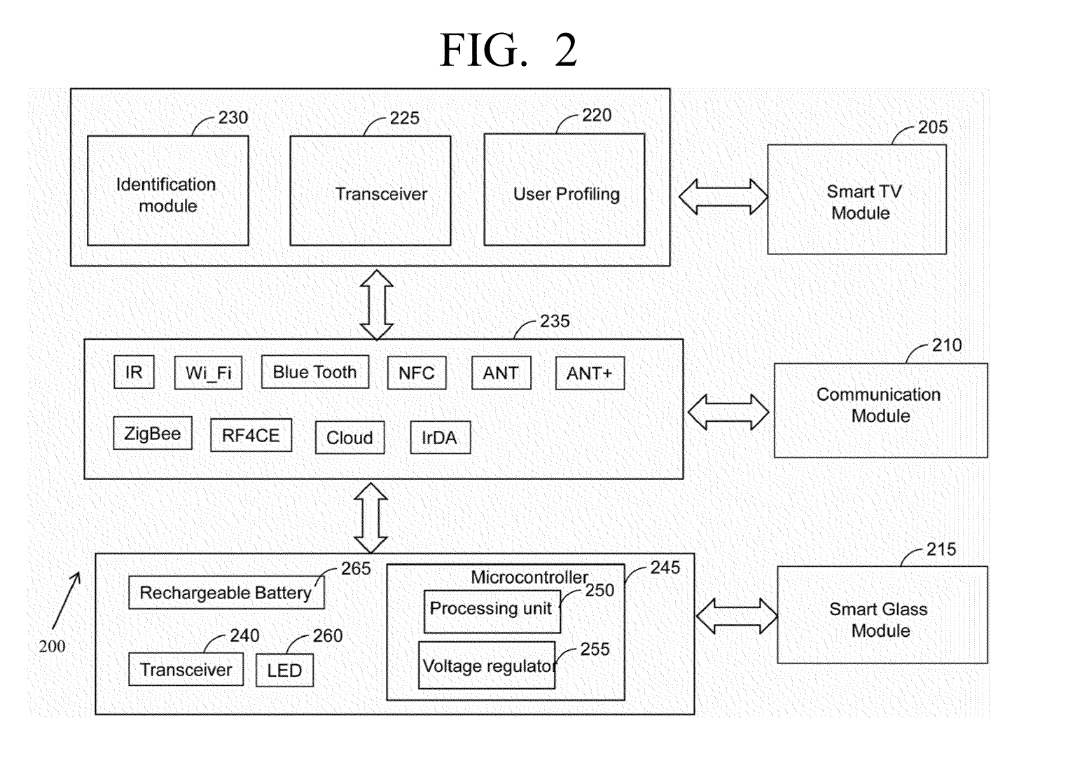

FIG. 2 illustrates the architecture of the proposed system. The system 200 includes a smart TV module 205, a communication module 210 and a smart glass module 215. The smart TV module 205 includes a user profiling module 220, a transceiver 225 and an identification module 230. The transceiver 225 communicates with a remote control to transmit and receive different signals. Further the transceiver 225 is able to fetch information from cloud source. The user profiling module 220 creates user profile of a plurality of users through the transceiver 225. Further, the smart TV module 205 stores user profile of a plurality of users in a memory. The user profile includes information related to a user such as identification information, favourite movies, favourite songs, recommendations and eye prescription details.

When a user appears before the smart TV module 205, the identification module 230 identifies the user. The identification is performed by identification techniques including but not limited to face detection, voice detection, cryptography technology, signature recognition method, biometrics, TV remote sensors and haptic technology. Further, the transceiver 225 sends the eye power details of the identified user to the smart glass module 215. A binary code corresponding to the eye prescription details is communicated to the smart glass module 215.

The communication between the smart TV module 205 and the smart glass module 215 occurs through the communication module 210. The communication module 210 performs communication using various communication protocols. Examples of communication protocols include but are not limited to infrared, Bluetooth, Wi-Fi, near field communication, ANT protocol, ANT+ protocol, ZigBee, RF4CE and infrared data association (IrDA) protocol.

The smart glass module 215 receives the eye prescription details communicated from the smart TV module 205. The smart glass module 215 includes a transceiver 240, a microcontroller 245, a light emitting diode (LED) 260 and a rechargeable battery 265. The transceiver 240 on the smart glass module 215 receives the eye prescription details from the smart TV module 205. The transceiver 240 receives a binary code corresponding to the eye prescription details of the user.

The transceiver 240 communicates the binary code to the microcontroller 245. The microcontroller 245 includes a processing unit 250 and a voltage regulator 255. The binary code is fed to the processing unit 250 of the microcontroller 245. The processing unit 250 identifies the eye prescription details of the user based on the binary code. Further, the processing unit 250 generates a voltage corresponding to the eye power of the user. The voltage is regulated by a voltage regulator 255 in the microcontroller 245. The voltage regulator 255 is an electronic component and is embedded in the glass frame of smart glass module 215. The voltage regulator 255 regulates voltage fed from the processing unit 250 to a constant voltage level.

Further the voltage is applied to lens of the smart glass module 215. The voltage applied to the smart glass module 215 generates an electric field, thereby changing the refractive properties and focal power of the smart glass module 215. As a result of the change in focal power, the user is provided with a normal vision

Further, the smart glass module 215 includes the LED 260 for providing different notifications to the user. The notifications communicated include battery charging, communication, power ON and power OFF. The rechargeable battery 265 provides sufficient power for the working of the smart glass module 215. The rechargeable battery 265 recharged by connecting to the smart TV module 205 or through a separate ensemble.

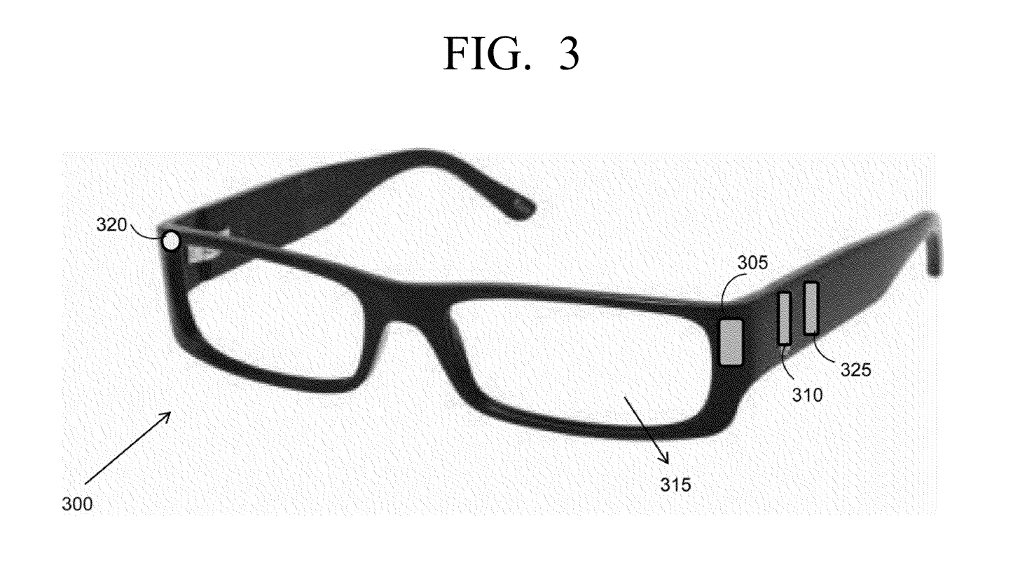

FIG. 3 is an exemplary illustration of a smart glass module of FIG. 2 in accordance with one embodiment the present invention. The smart glass 300 includes a transceiver 305, a microcontroller 310, a liquid crystal (LC) glass 315, an infrared light emitting diode (LED) 320 and a battery 325. The smart glass 300 is initially registered to a display device with a unique identification number. Examples of the display device include but are not limited to a smart television, a 3D television, a monitor and a smartphone. The display device creates and stores the user profile of a plurality of users. The user profile can be either created in the display device or can be fetched from a cloud. The display device identifies a user in the vicinity of the display device and communicates the information in the user profile to the smart glass 300 registered to the display device. The user profile includes information such as identification information and eye prescription details. The eye power prescription includes myopia power and hyperopia power.

The display device communicates the eye prescription details to the smart glass 300 via different communication protocols. A binary code corresponding to the myopia power in the eye prescription details is communicated to the smart glass 300. The binary code corresponding to the eye prescription details can be obtained from a lookup table stored in the display device. The myopia power of the user is mapped to the binary code in the lookup table. The corresponding binary code is communicated to the smart glass 300. Further, based on various communication protocols, different data (code) can be sent to the smart glass 300. The following table (Table 1) illustrates an exemplary lookup table stored in the display device.

TABLE 1

| | User's eye prescription value |
|---|---|
| Binary Code | stored in TV |
| 0000 | For checking compatibility |
| 0001 | 0.25 D |
| 0010 | 0.50 D |
| 0011 | 0.75 D |
| 0100 | 1.0 D |
| . . . | . . . |
| . . . | . . . |
| . . . | . . . |
| 1110 | 5.75 D |
| 1111 | 6.00 D |

The transceiver 305 on the smart glass 300 receives the eye prescription details from the display device. The transceiver 305 receives binary code corresponding to the myopia power of the user. Normally, the myopia power of left eye and right eye is different for a user. The binary code communicated is usually an eight bit signal out of which first four bits represent the myopia power of the left eye and the last four bits represent the myopia power of the right eye. For example suppose the binary code sent from the display device is ‘00100100’. According to, Table 1, the data will be received at the transceiver 305 as follows 00100100=0010 0100

The transceiver 305 communicates the binary code to the microcontroller 310. The microcontroller 310 processes the binary code to identify the myopia power of the user. In the above example the received signal ‘00100100’ is processed by the microcontroller 310. The microcontroller 310 identifies the myopia power of left eye as 0.5 Dioptre corresponding first four bits of binary code ‘0010’. Further the microcontroller 310 identifies the myopia power of the right eye as 1.0 Dioptre corresponding to last four bits ‘0100’. The microcontroller 310 generates a first voltage signal based on the myopia power of the left eye of the user. Further, the microcontroller 310 generates a second voltage signal based on the myopia power of the right eye of the user. The first voltage signal and the second voltage signal generated by the microcontroller 310 are further applied to the LC glass 315.

The LC glass 315 includes a first lens and a second lens. The first voltage signal received from the microcontroller 310 is applied to the first lens. Further, the second voltage signal from the microcontroller 310 is applied to the second lens. The first voltage signal and the second voltage signal applied to the LC glass 315 generate an electric field across the LC glass 315. LC molecules in the LC glass 315 orient in a different direction thereby changing the refractive properties and focal power of the LC glass 315. As a result of the change in focal power, the user is provided with a perfect normal vision along with a 3D vision.

Further, the smart glass 300 includes the infrared LED 320 for providing different notifications to the user. The notifications communicated include battery charging, communication, power ON and power OFF. The infrared LED 320 blinks and change color to provide information about exhausting battery charge and full charge of battery. Further the infrared LED 320 provides information regarding a communication occurring between the smart glass 300 and the display device. The infrared LED 320 blinks rapidly to notify the communication. Furthermore, the infrared LED 320 notifies the power ON and power OFF of the smart glass. Moreover, the infrared LED 320 can provide identification among a plurality of smart glasses. Among the plurality of smart glasses, the display device may link with the smart glass 300. The infrared LED 320 of the smart glass 300 to notify the user that smart glass 300 is being used.

The battery 325 provides sufficient power for the working of the smart glass 300. The battery 325 is a rechargeable battery recharged by connecting to the display device or through a separate ensemble. The battery 325 is enclosed in glass frame of the smart glass 300 at an appropriate place taking into consideration the weight, size and alignment of the battery 325.

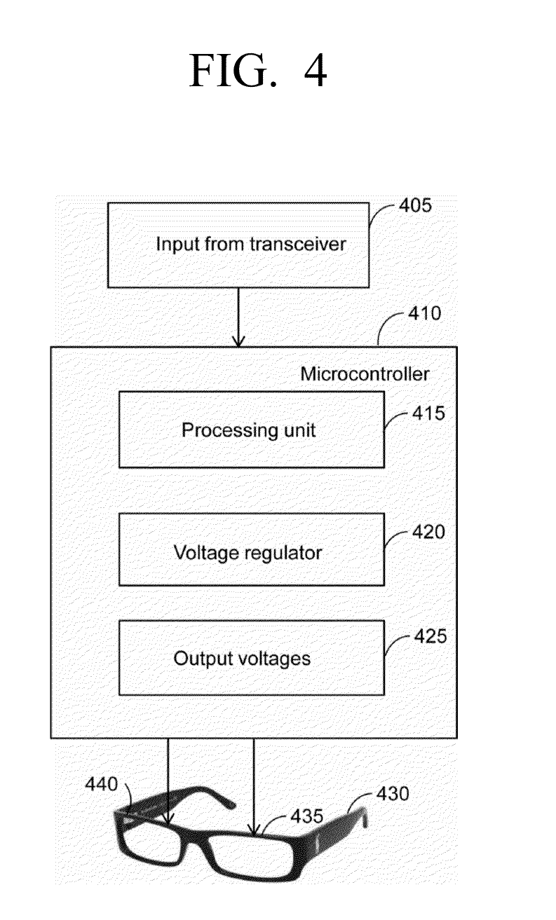

FIG. 4 is an internal block diagram of a microcontroller embedded in a smart glass. The microcontroller 410 includes a processing unit 415 and a voltage regulator 420. The microcontroller 410 receives input 405 from a transceiver in the smart glass 430. The input 405 includes a binary code. The binary code corresponds to the myopia power of the user. Further, the lookup table have details of the binary codes and corresponding myopia power. The input 405 is fed to the processing unit 415 of the microcontroller 410. The processing unit 415 identifies the myopia power of the user by comparing the binary code and the lookup table. Further, the processing unit 415 generates a voltage corresponding to the myopia power of the user. The voltage is regulated by a voltage regulator 420 in the microcontroller 410. The voltage regulator 420 regulates voltage fed from the processing unit 415 to a constant voltage level.

Normally, the myopia power of left eye will be different from the myopia power of right eye of the user. Therefore the input received from the transceiver will be an binary code, for example an eight bit binary code. In the eight bit binary code, the first four bits representing the myopia power of the left eye and the last four bits represent the myopia power of the right eye of the user. The processing unit 415 identify the myopia power of the left eye by mapping the first four bits of the eight bit binary code with the lookup table. Further, the processing unit 415 identify the myopia power of the right eye by mapping the last four bits of the eight bit binary code with the lookup table. The processing unit 415 generate a first voltage signal corresponding to the myopia power of the left eye and a second voltage signal corresponding to the myopia power of the right eye.

The first voltage signal and the second voltage signal are fed to the voltage regulator 420. The voltage regulator 420 regulates the first voltage signal and the second voltage signal to a constant level. The output voltage 425 includes the regulated outputs of the voltage regulator 420. The output voltage 425 is fed to the Liquid crystal glass of the smart glass 430. The first voltage signal is applied to the first lens 435 to compensate the myopia power of the left eye. The second voltage signal is applied to the second lens 440 to provide myopia power correction for right eye. Based on the first voltage signal, the orientation of the Liquid crystal (LC) molecules in the first lens 435 of Liquid crystal glass changes thereby changing the refractive property of the first lens 435. Therefore the focal power of the first lens 435 is adjusted to compensate for the myopia power correction of left eye. Further, based on the second voltage signal, the orientation of the LC molecules in the second lens 440 of Liquid crystal glass changes thereby changing the refractive property of the second lens 440. Therefore the focal power of the second lens 440 is adjusted to compensate for the myopia power correction of right eye. The user is finally provided with a perfect normal vision.

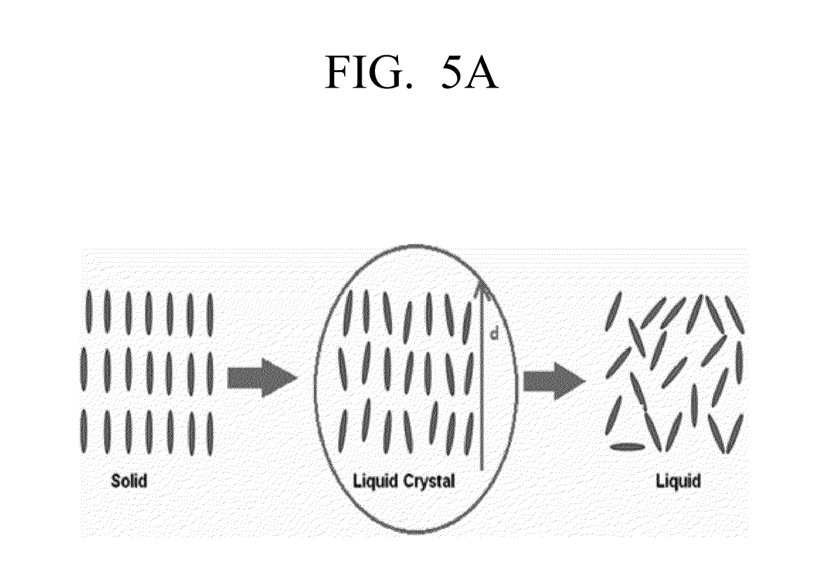

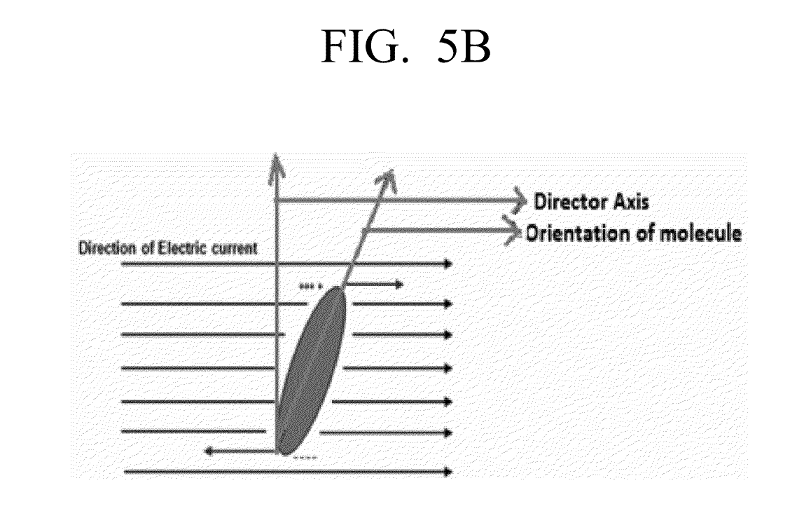

FIG. 5A illustrates the different states of a matter. In solid state all the molecules are arranged in an orderly repeating pattern. Liquid crystal state is a state having properties between those of conventional liquid and solid state. In the liquid crystal state, all the molecules of the material will point in the same direction along director, showing uniaxial symmetry. Director is a common axis along which all the molecules in a liquid crystal are pointing. Therefore, in liquid crystal state, rotation of molecules around director axis does not make any difference. In liquid state all the molecules are loosely bound. The molecules are randomly spaced and oriented.

FIG. 5B illustrates the effect of voltage on liquid crystal (LC) molecules. The smart glass in accordance with the present invention is an LC glass. The smart glass controls the refractive property by applying a voltage signal to the LC glass. The voltage signal applied to the LC glass creates an electric field. Due to the electric field created, the reorientation of the LC molecules occurs in the LC glass. The LC molecules have an anisotropy called uniaxial anisotropy because all the LC molecules are rotationally-symmetric with respect to the director. As a result of uniaxial anisotropy, the electric field experiences a different dielectric constant when oscillating in a direction parallel or perpendicular to the director. Due to the uniaxial anisotropy, dielectric displacement and induced dipole moment are not parallel to the electric field, except when the director is parallel or perpendicular to the electric field. As a result, a torque is exerted on the director. For the LC glass with positive anisotropy, the director prefers to align parallel to the electric field. The LC glass with a negative anisotropy tends to orient the LC molecules perpendicularly to the electric field.

Due to orientation of the LC molecules, the properties of LC glass such as transparency and focal power can be changed. Therefore when a user having a myopia power appears before the display device, the myopia power is communicated with the smart glass. The smart glass applies a voltage corresponding to myopia power of the user. A corresponding electric field is generated based on the voltage applied. This results in a change in refractive properties and focal power thereby providing the user a perfect normal vision along with 3D vision.

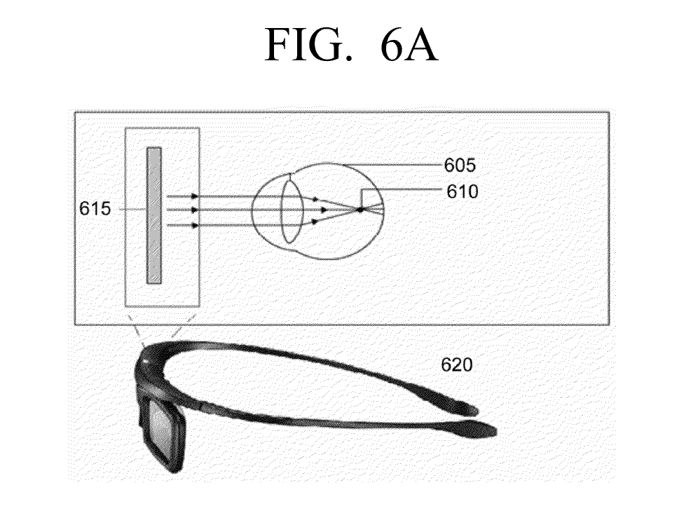

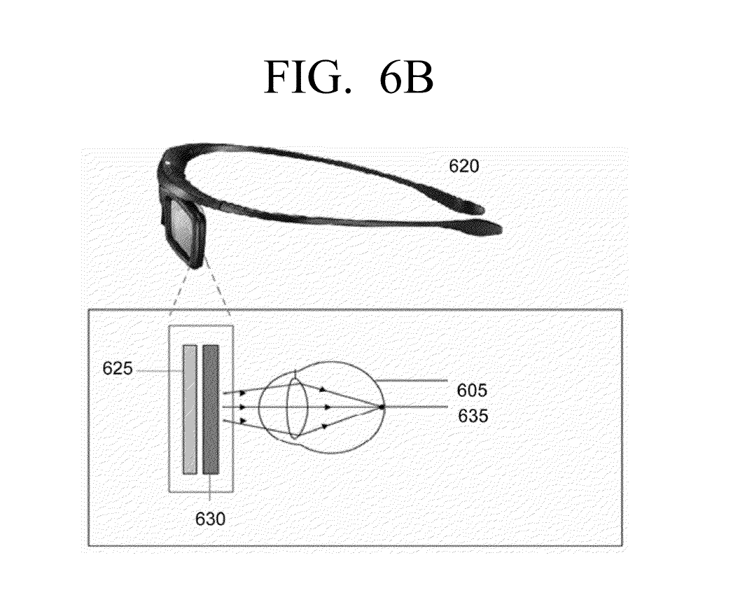

FIG. 6A illustrates the scenario when glass 620 is a 3D glass. The 3D glass 620 includes an Liquid crystal glass 615 generating a 3D image. When a myopic person is using the 3D glass 620, a 3D image is formed. In this arrangement, the 3D image is formed at a point 610 in front of the retina 605. Therefore, the image produced is a blurred 3D image.

FIG. 6B illustrates the scenario when the glass 620 is a smart glass. The smart glass includes an Liquid crystal glass 625 and a correction layer 630. When the myopic person is using the smart glass 620, a perfect 3D image is formed. The smart glass 620 is capable of identifying the myopia power of the user. Further, the smart glass 620 is capable of automatically controlling the refractive property of the correction layer. In this arrangement, the image is formed at a point 635 on the retina 605. The Liquid crystal glass 625 produces a 3D vision and the correction layer 630 produce a normal vision for the user. Therefore a perfect 3D vision is provided to the myopic person eliminating the need of wearing two different glasses.

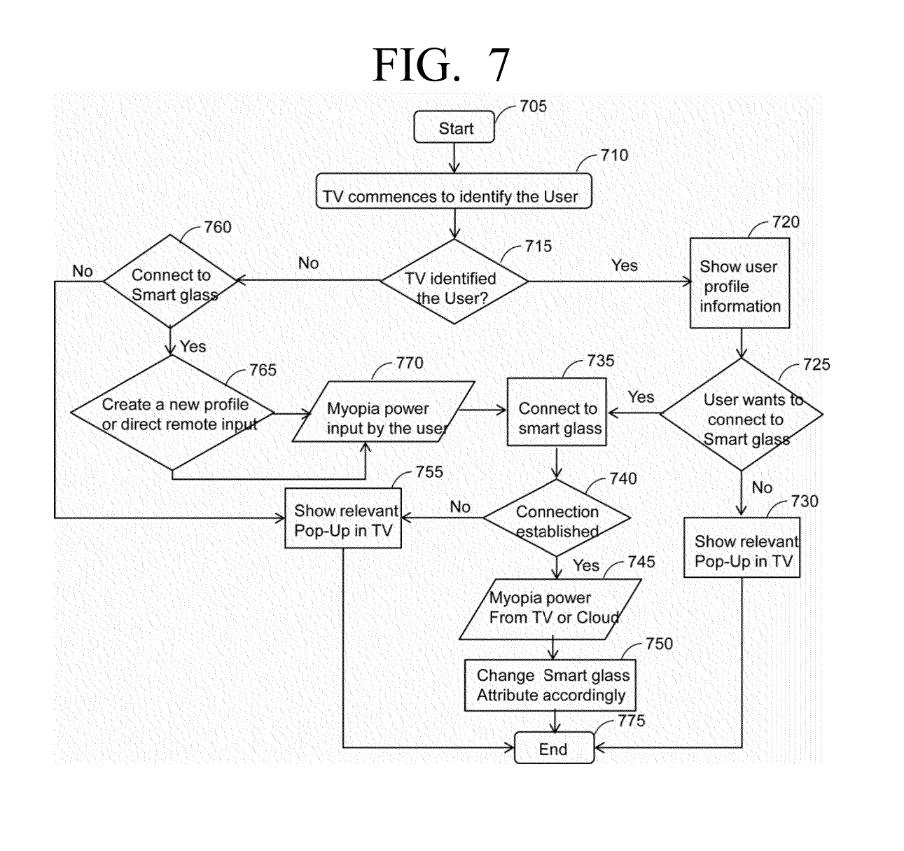

FIG. 7 is a flowchart illustrating the steps of controlling the refractive index of a smart glass. The process starts at step 705.

At step 710, the TV commences to identify a user appearing in front of the TV. The identification is performed by various identification techniques including but not limited to face detection, voice detection, cryptography technology, signature recognition method, biometrics, TV remote sensors and haptic technology.

At step 715, it is checked if the TV has identified the user. If the TV has identified the user, the process proceeds to step 720. If the user is not identified, the process proceeds to step 760.

At step 720, the TV displays the user profile information of the identified user. The user profile information include related to a user such as identification information, favourite movies, favourite songs, recommendations eye prescription details.

At step 725, it is checked if the user wants a connection to be established between TV and smart glass. If the user doesn't have any vision problem, there is no requirement of a connection to be established. The process proceeds to step 730. If a connection has to be established then the process proceeds to step 735.

At step 730 a relevant pop-up is shown in the TV and the process ends at step 775.

At step 735, the user tries to connect to the smart glass with the TV. The refractive properties of the smart glass can be changed through the TV once a connection is established.

At step 740, a connection is established by one of a communication protocol. The various communication protocols includes but is not limited to infrared, Bluetooth, Wi-Fi, near field communication, ANT protocol, ANT+ protocol, ZigBee, RF4CE and infrared data association (IrDA) protocol. If the connection is established the process proceeds to step 745. If the connection is not established the process proceeds to 755.

At step 745, once the connection is established the myopia power of the user stored in the TV is communicated to the smart glass. If the information of myopia power is not stored in the TV, then the information is fetched from a cloud source and is communicated to the smart glass.

At step 750, the smart glass change the refractive property or focal power based on the myopia power of the user and the process ends at step 775.

At step 755, a relevant pop-up is shown in the TV when the connection is not established. Further process ends at step 775.

At step 760, the smart glass tries to connect to the TV even if the user is not identified. The step 760 occurs when a new user appears in front of the TV and when user profile information is unavailable in the TV. If the connection is established, the process proceeds to step 765. If the connection is not established, the process proceeds to step 755 to show a relevant pop-up and the process ends at step 775.

At step 765, a new profile of the user is created and stored in the TV. The new profile can be created by giving the remote control inputs. Further, the new profile can be created by fetching information from a cloud source.

At step 770, the user gives the myopia power input to the TV. Further, if the connection is maintained steps 735 to 750 repeats thereby controlling the refractive index properties of smart glass.

The process ends at step 775.

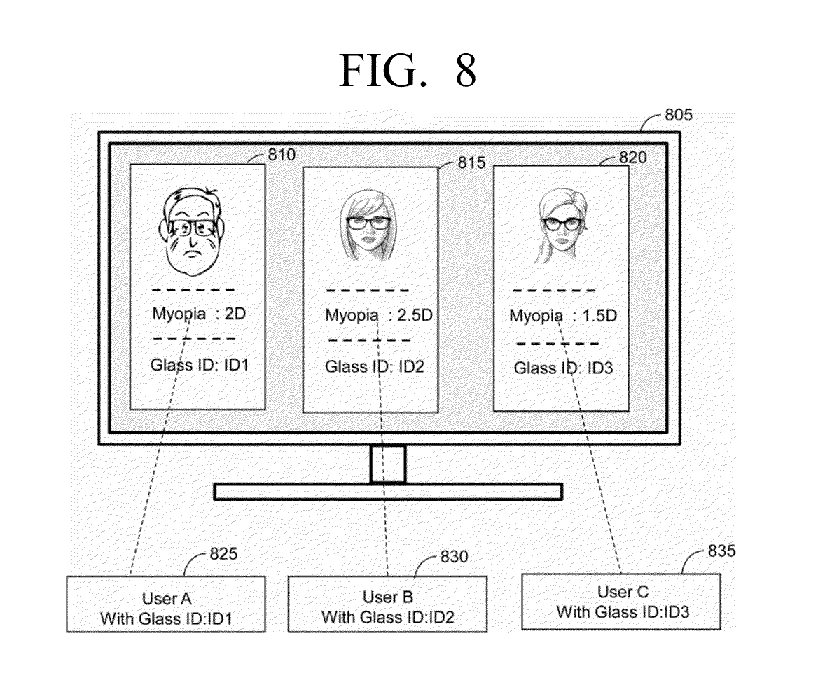

FIG. 8 is an exemplary illustration of a multi-user scenario viewing a display device. In one embodiment, the display device is a smart television (TV) 805. The smart TV 805 stores the user profile of each user among a plurality of users in a memory. The user profile includes information related to a user such as identification information, favourite movies, favourite songs, recommendations and eye prescription details. The eye prescription details include myopia power of the user. In FIG. 8, the smart TV 805 displays the a first user profile 810 of a user A, a second user profile 815 of a user B and a third user profile 820 of a user C. The user profile can either be entered using a remote control or can be fetched from a cloud source.

Initially, a plurality of smart glass is registered with the smart TV 805. Each smart glass is registered with a unique identification number. The plurality of smart glass includes a first smart glass 825, a second smart glass 830 and a third smart glass 840. The first smart glass 825 is registered with the smart TV 805 using a unique identification number ID1. Further, the second smart glass 830 is registered with the smart TV 805 using a unique identification number ID2. Furthermore, the third smart glass 835 is registered with the smart TV 805 using a unique identification number ID3.

In one embodiment, user A, user B and user C appears in front of the smart TV 805 to view a program. The user A, the user B and the user C are having myopia power for the eyes. The smart TV 805 identifies each user one by one. The identification is performed by various identification techniques including but not limited to face detection, voice detection, cryptography technology, signature recognition method, biometrics, TV remote sensors and haptic technology. Further the plurality of smart glasses registered to the smart TV 805 is identified.

The smart TV 805 links unique user profile of each user with a smart glass among the plurality of smart glasses. In FIG. 8, the first user profile 810 of user A is linked to the unique identification number ID1 of the first smart glass 825. Further, the second user profile 815 of user B is linked to the unique identification number ID2 of the second smart glass 830. Furthermore, the third user profile 820 of user C is linked to the unique identification number ID3 of the third smart glass 835. The smart TV 805 can inform the user A about the first smart glass 825 linked to first users profile 810 by showing a pop-up in the smart TV 805 or blinking the infrared LED of the first smart glass 825. Similarly, the user B and the user C can be informed about the smart glass linked to the user profile.

After linking, the information about myopia power of the user A is communicated from the smart TV 805 to the first smart glass 825. In the present example, the myopia power of the user A is 2 Dioptre. The first smart glass 825 identifies the myopia power of the user A and generates a first voltage signal. The first voltage signal is further applied to the first smart glass 825 to control the refractive property of the first smart glass 825, thereby changing the focal power. Therefore, the user A is provided with a vision along with a perfect normal vision compensating the myopia power. Further, the user can view 3D or 2D data based on display technology.

Similarly, the myopia power of the user B is communicated from the smart TV 805 to the second smart glass 830. In the present example, the myopia power of the user B is 2.5 Dioptre. The second smart glass 830 identifies the myopia power of the user B and generates a second voltage signal. The second voltage signal is further applied to the second smart glass 830 to control the refractive property of the second smart glass 830, thereby changing the focal power. Therefore the user B is provided with a vision along with a perfect normal vision compensating the myopia power. Further, the user can view 3D or 2D data based on display technology.

Further, the myopia power of the user C is communicated from the smart TV 805 to the third smart glass 835. In the present example, the myopia power of the user C is 1.5 Dioptre. The third smart glass 835 identifies the myopia power of the user C and generates a third voltage signal. The third voltage signal is further applied to third smart glass 835 to control the refractive property of the third smart glass 835, thereby changing the focal power. Therefore the user C is provided with a vision along with a perfect normal vision compensating the myopia power. Further, the user can view 3D or 2D data based on display technology.

The refractive property of each smart glass is corrected one by one according to the myopia power of each user viewing the smart TV 805. Therefore multiple users can watch the smart TV 805, without bothering about the myopia power.

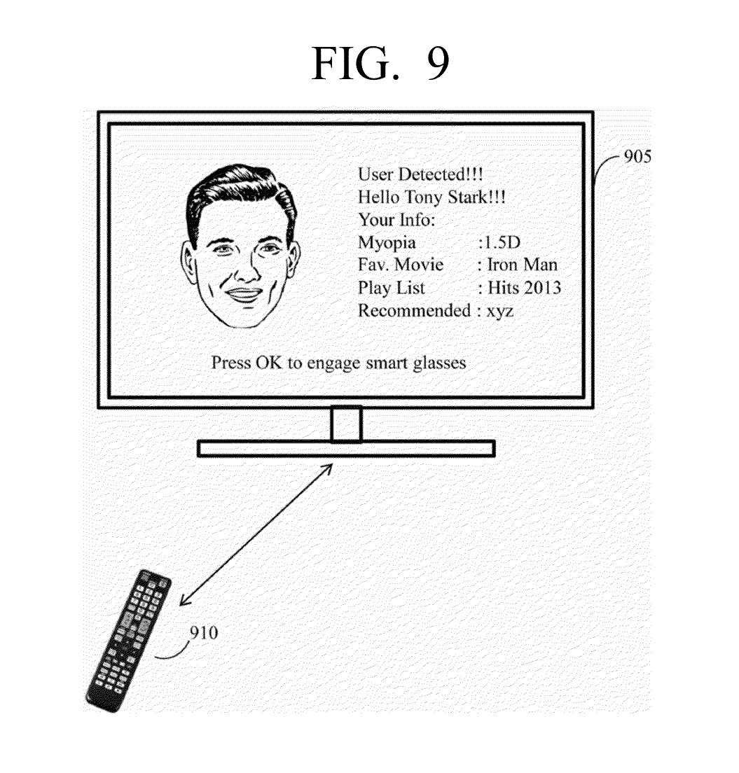

FIG. 9 illustrates creating a user profile in a display device 905, in accordance with one embodiment of the present invention. A user can create and store a user profile in a memory of the display device 905. The user profile includes information related to a user such as identification information, favourite movies, favourite songs, recommendations and eye prescription details. The identification information includes but is not limited to signature, face and biometrics. The eye prescription details include eye power. The user profile can be created by providing input with remote control 910 of the display device 905. In some embodiments, other methods not limited to, voice and gesture can be used to create the user profile. Further, another mode of input includes fetching the information already stored in a cloud by the user. The identification of the user appearing before the display device is performed by the display device using the information stored in the user profile.

In one embodiment of the present invention, the myopia power of the user is saved to the eye prescription details. When the user appears in front of the display device, the user is identified. In FIG. 9 face detection method can be used to identify the user as the features are stored in the user profile. When the user is identified, the myopia power of the user already stored in the eye prescription details is communicated to a smart glass. If the information regarding the myopia power is not stored, then the user can provide the information using the remote control 910 or using any other methods not limited to such as voice and gesture. The smart glass will automatically control the refractive property of the lens, thereby providing a perfect 3D vision to the user.

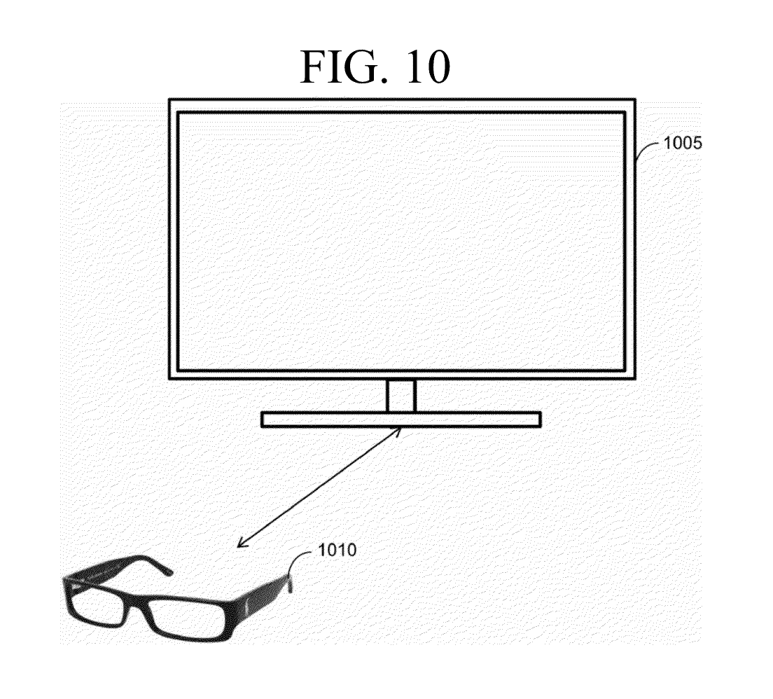

FIG. 10 illustrates the communication of display device with a smart glass in accordance with another embodiment of the present invention. The display device 1005 creates and stores the user profile of each user among a plurality of users. The display device 1005 communicates the eye prescription details including myopia power stored in the user profile. The communication is performed by different communication modes and protocols including but not limited to infrared, Bluetooth, Wi-Fi, near field communication, ANT protocol, ANT+ protocol, ZigBee, RF4CE and infrared data association (IrDA) protocol. The smart glass 1010 receives the eye prescription details regarding the myopia power. The smart glass 1010 generates a voltage signal corresponding to the eye prescription details. The voltage signal generated is applied to a first lens and a second lens of the smart glass 1010.

Often, the left eye and right eye of the user may have different myopia power. In such case, a first voltage signal is generated corresponding to the myopia power of the left eye. Further, a second voltage signal is generated corresponding to the myopia power of the right eye. The first voltage signal is applied to the first lens and the second voltage signal is applied to the second lens of the smart glass 1010. The smart glass 1010 is a liquid crystal glass. When a voltage corresponding to the myopia power is applied to the liquid crystal, the smart glass 1010, adjust the refractive property of the lens. The user is thereby provided with a 3D vision along with normal vision.

In one embodiment of the present invention, a similar scenario of controlling the refractive properties of a smart glass can be implemented for compensating hyperopia power. In this case the user profile can be stored in a smartphone and can be communicated to the smart glass by various communication protocols. The refractive properties of the smart glass can be adjusted in outdoor environment through the smart phone.

In another embodiment of the present invention the user profile can be stored in the display device. In this case, the user appearing before a display device is identified based on biometric information detected by biometric sensors or glasses. The display device communicates a control signal representing the identified user to the smart glass. The smart glass control the refractive property based on the user profile on receiving the control signal. Further in one embodiment, the scope of the present invention can be extended to doctor consultation and eye power measurement by applying variable voltage on the smart glasses.

In yet another embodiment, the user profile is stored in smart glass. Users can be detected based on various methods such as finger prints, biometric, face detection and so on.

Advantageously, the embodiments specified in the present disclosure enables the automatic control of user prescription power of a smart glass through a display device. The control is based on the user profile stored in the display device. Further, the smart glass is generic and can be used by any person. The smart glass provides a 3D vision along with a perfect normal vision. Therefore it eliminates the need of wearing a 3D glass over a prescription glass. Further the smart 3D vision can be used in a 2D viewing scenario. Further the smart glass saves cost because of the use of a single glass instead of a 3D glass and a prescription glass. Further, there is no need of a clamping device for holding the 3D glass and prescription glass together. Furthermore it is useful in a scenario where the eye power of the person changes continuously. The power of the smart glass can be controlled automatically according to the changing eye power.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below.

Accordingly, the specification and figures are to be regarded as illustrative examples of the present disclosure, rather than in restrictive sense. All such possible modifications are intended to be included within the scope of present disclosure.

What is claimed is:

1. A method of controlling refractive property of a smart glass, the method comprising:
identifying a user wearing the smart glass;
communicating eye prescription details of the user to the smart glass, wherein the eye prescription details are stored in a user profile; and
controlling refractive property of the smart glass based on the eye prescription details.

2. The method as claimed in claim 1 and further comprising:
storing user profiles of a plurality of users in at least one of a display device, a server, and the smart glass, wherein the user profile comprises an identification information and the eye prescription details of the user.

3. The method as claimed in claim 1, wherein the display device is one of smart television, 3D television, computer monitor, and smart phone.

4. The method as claimed in claim 1, wherein the identification is performed by one of face detection, voice detection, cryptography technology, signature recognition method, biometrics, identification techniques using TV remote, and haptic technology.

5. The method as claimed in claim 1, wherein the communication is performed by one of infrared, Bluetooth, Wi-Fi, near field communication, ANT protocol, ANT+ protocol, ZigBee, RF4CE and infrared data association (IrDA) protocol.

6. The method as claimed in claim 1 and further comprising:
registering a plurality of smart glass with a unique identification number, wherein registration is performed in the display device;
identifying a user profile for each user wearing a smart glass in front of the display device from a plurality of user profiles;
associating each user profile to the unique identification number of the smart glass; and
controlling the refractive index of each of the plurality of smart glass based on the eye prescription details of each user corresponding to the linking.

7. A smart glass capable of controlling refractive property, the smart glass comprising:
a transceiver to receive an input signal from a display device, wherein the input signal corresponds to eye prescription details of a user;
a microcontroller to identify the input signal, the microcontroller comprising:
a processing unit to process the input signal to identify the eye prescription details of the user;
a voltage regulator to generate a voltage signal based on the eye prescription details; and
a control unit to control the refractive property of the smart glass, wherein the refractive property is controlled based on the voltage signal.

8. The smart glass as claimed in claim 7, further comprising:
an indicator light emitting diode (LED) to convey notifications to the user; and
a rechargeable battery to provide power required for the smart glass.

9. The smart glass as claimed in claim 7, wherein the eye prescription details comprises details of myopia power and hyperopia power.

10. The smart glass as claimed in claim 7, wherein the indicator LED provide notification comprising battery charging, communication, power ON and power OFF.

11. The smart glass as claimed in claim 7, wherein the control unit controls at least one of a correction layer and a liquid crystal layer.

12. The smart glass as claimed in claim 7, wherein the smart glass is capable of providing 2D vision and 3D vision.
